(19) United States
(12) Patent Application Publication
(10) Pub. No.: US 2002/0040345 A1
(43) Pub. Date: Apr. 4, 2002

(54) Home banking system and method thereof

(75) Inventor: Jun Kim, Suwon (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/003,442

(22) Filed: Dec. 6, 2001

Related U.S. Application Data
(63) Continuation of application No. 09/198,244, filed on Nov. 24, 1998.

(30) Foreign Application Priority Data
Nov. 24, 1997 (KR) 62393/1997

(51) Int. Cl. G06F 17/60

(52) U.S. Cl. 705/42; 705/39

(57) ABSTRACT

A home banking system for receiving bank service and doing home-shopping by using a personal computer connected to a card interface unit, and a method thereof, wherein the home banking system includes: a computer for data-communicating with a bank system through a modem; and the card interface unit for reading coded information on a card or recording coded information on the card, and generating coded information to be transmitted to the bank system, thereby easily and safely providing the bank service and home-shopping.

### BACKGROUND OF THE INVENTION

1. Field of the Invention

The present invention is directed to an apparatus for accessing and receiving service from a company issuing a card and a method thereof, and in particular to an apparatus for accessing and receiving service from a company issuing a card by employing a card interface unit, and a method thereof. The present invention especially relates to a home banking system for accessing and receiving banking services and doing home-shopping by using a personal computer(PC) connected to a card interface unit, and a method thereof.

2. Description of the Background Art

According to a first conventional art, when receiving bank service by using a bank terminal, a banking client must bring a card issued from a bank and receive the banking service from the bank terminal(ATM) or another bank terminal installed in a specific place. Here, in case someone else is already using the terminal, the client must wait his/her turn to receive the banking service. When the client intends to receive the banking service by using the terminal, he must input his account number, identification number and/or secret personal identification number pursuant to instructions displayed on the terminal. If the client inputs incorrect information, he must inconveniently repeat the step of inputting the information again correctly. Thus, it may take a longer time, requiring other clients to wait to use the bank service. In addition, while the client is inputting the information, there exists a risk of information exposure.

According to a second conventional home banking service using a computer, a bank client must firstly subscribe to a communication service company, and use the home banking service provided by the company. That is, in case the client connects to a specific bank system by using the home banking service, the bank system demands his information. If the client's information, for instance account number, secret number and password, is inputted, the communication service system transmits the information to the bank system. When the inputted information is identical to the information of the client registered in the bank, the client can receive the banking service. Here, the inputted information may be hacked by a hacker if it does not go through any security process at all. In addition, the client can use the bank service only when he inputs the secret number as registered in the bank. In case the client wishes to change his registered secret number, he must go to the bank in person. That is, unless the client changes his secret number in the bank, he must use the registered one.

Accordingly, when a client accesses the bank service by using the conventional home banking system or bank terminal, he must input his information one by one and the information may be exposed. The present invention serves to provide a new home banking system capable of solving the above-mentioned problems.

### SUMMARY OF THE INVENTION

It is therefore a primary object of the present invention to provide a home banking system which can connect to a bank computer network by using a card interface unit connected to a computer, reading and decoding coded information, re-encoding the decoded information, and recording the re-encoded information in order for a user to access banking services from home.

It is another object of the present invention to provide a home banking method which can allow a user to access banking services from home by using a card interface unit connected to a computer, reading and decoding coded information, re-encoding the decoded information, and recording the re-encoded information.

According to a first embodiment of the present invention, a home banking system is embodied by installing a card interface unit to a computer provided with a modem in order to communicate with a bank computer network and by installing a driving software recognizing the card interface unit.

Here, the card interface unit includes: a control unit outputting a control signal under the control of the computer; a card input unit reading or recording coded information pursuant to the control signal from the control unit; a first coding unit decoding the coded information outputted from the card input unit or generating coded information pursuant to the control signal from the control unit; a processing unit loading the decoded information outputted from the first coding unit on a system bus, or fetching and outputting the decoded information loaded on the system bus to the first coding unit, pursuant to the control signal from the control unit; and a second coding unit re-encoding the decoded information outputted from the processing unit and loading the re-encoded information on the data bus.

In accordance with a second embodiment of the present invention, there is provided a home banking method including: transmitting coded information recorded on a bank client's card issued from a bank to a bank computer network; inputting a secret number when a connection is allowed by confirming whether the coded information and card are registered in the bank through a bank system connected to the bank computer network; coding the secret number and transmitting the coded secret number to the bank system; and carrying out a bank task pursuant to the client's instructions when the coded secret number is identical to the client's secret number registered in the bank system.

### BRIEF DESCRIPTION OF THE DRAWINGS

The present invention will become better understood with reference to the accompanying drawings which are given only by way of illustration and thus are not limitative of the present invention, wherein:

FIG. 1 is a schematic block diagram illustrating a home banking system according to the present invention which is connected to a bank computer network; and

FIG. 2 is a detailed schematic block diagram illustrating a card interface unit according to the invention.

### DETAILED DESCRIPTION OF THE INVENTION

The constitution of a home banking system according to the present invention will now be described with reference to the accompanying drawings.

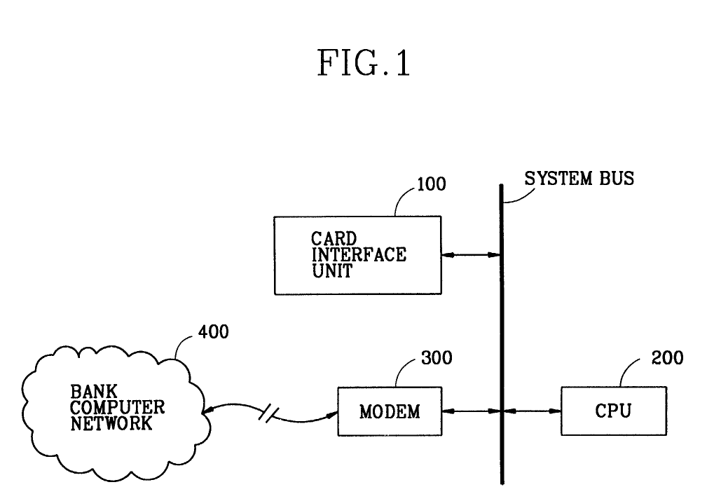

FIG. 1 is a schematic block diagram illustrating the home banking system of the present invention which is connected to a bank computer network. As illustrated therein, the home banking system includes: a personal computer (not shown) having a system bus connected to a modem 300 for communication and also having a central processing unit 200 connected to the system bus, and a card interface unit 100 connected to the system bus of the computer. The bank computer network 400 is connected to the modem 300 of the home banking system through a telephone line.

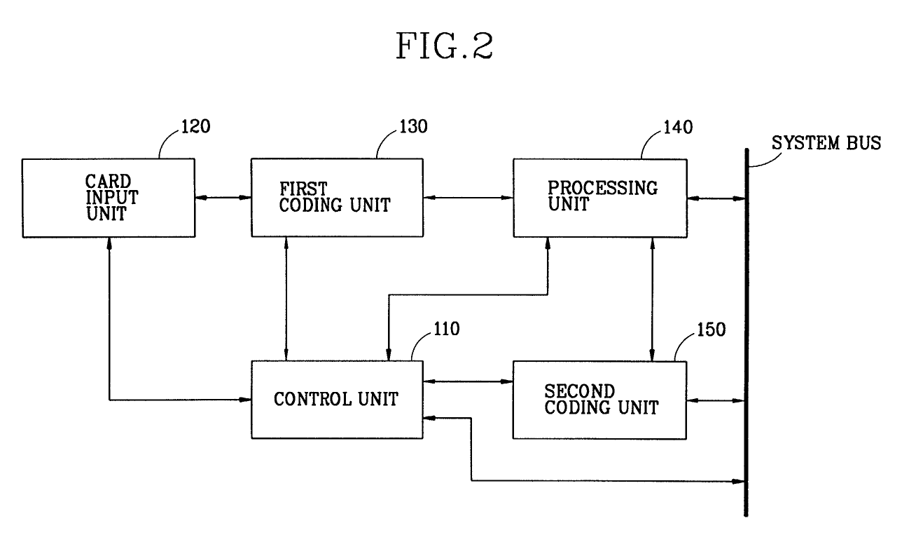

FIG. 2 is a detailed block diagram illustrating the card interface unit 100. As shown therein, the card interface unit includes: a control unit 110 outputting a control signal under the control of the central processing unit CPU in the computer executing a program for the home banking system; a card input unit 120 receiving a card issued from a bank (not shown), and reading information from the card or recording information on the card pursuant to the control signal from the control unit 110; a first coding unit 130 sending/receiving a data to/from the card input unit 120 pursuant to the control signal from the control unit 110; a processing unit 140 connected to the first coding unit 130 and sending/receiving a data to/from the first coding unit 130 pursuant to the control signal from the control unit 110, and fetching the data by loading it on the system bus; and a second coding unit 150 sending/receiving a data to/from the processing unit 140 pursuant to the control signal from the control unit 110, and fetching the data by loading it to the system bus.

Here, the card input unit 120 of the card interface unit 100 is separated from the unit 100 and installed to a casing of the computer main body, similarly to a floppy disk drive. Also, the card interface unit 100 may be manufactured as a portable external unit in order to be connected to the computer through a parallel port, a serial port, an universal system bus (USB) port, and the like.

The operation of the home banking system according to the present invention will now be explained.

According to a first embodiment of the present invention, a program (not shown) recognizing the card interface unit 100 should be firstly run in the computer in order to access and receive the banking service by using the home banking system.

When the program recognizing the card interface unit 100 is run, the central processing unit CPU in the computer operates the card interface unit 100 by recognizing the unit 100 and controlling the control unit 110.

The operation of the home banking system according to the present invention will now be described when the control unit 110 controls the card input unit 120, the first coding unit 130, the processing unit 140 and the second coding unit 150, and the card interface unit 100 is in a read mode.

When the card input unit 120 reads the coded information recorded on a bank card and outputs the information to the first coding unit 130, the first coding unit 130 decodes the coded information and outputs the decoded information to the processing unit 140. Here, the processing unit 140 loads the decoded information to the system bus. When the second coding unit 150 fetching the decoded information under the control of the CPU encodes the information again and outputs the re-encoded information to the modem 300 through the system bus, the modem 300 is connected to the bank computer network 400 through a telephone line, and thus connected to a bank system (not shown) on which the user is registered. In case the user is confirmed by the bank system to be a client registered in the bank, it is demanded to input the client's secret number. When the client inputs the secret number, the second coding unit 150 encodes the secret number and outputs the coded secret number to the system bus. Then, the modem 300 fetches and transmits the coded secret number to the bank system. The bank system compares the encoded secret number with the registered client's secret number In the case that the two numbers are identical to each other, the client is allowed to connect to the bank system, and thus can use the banking service.

In addition to the read mode, the home banking system according to the present invention further includes a write mode, which will now be described.

Pursuant to the control of the CPU, the second coding unit 150 decodes the coded information of the bank service result, loads the decoded information on the system bus, and displays the information on a monitor(not shown) in order for the user to confirm the bank service result. According to a confirm command from the user, the processing unit 140 outputs the information of the bank service result to the first coding unit 130. The first coding unit 130 encodes the information and outputs the encoded information to the card input unit 120. The card input unit 120 records the encoded information on the user's card issued from the bank.

That is, the home banking system according to the present invention allows its user to use various kinds of secret numbers, encode the secret number, and transmit and register the coded secret number to the bank system, and thus the secret number is less susceptible to being hacked by hackers due to improved security. Accordingly, the home banking system of the present invention can advance the online commerce and currency times.

In accordance with a second embodiment of the present invention, a home banking method includes: transmitting coded information recorded on a client's card issued from a bank to a bank computer network; inputting a secret number when a connection is allowed by confirming whether the coded information and card are registered in the bank through a bank system connected to the bank computer network; encoding the secret number and transmitting the coded secret number to the bank system; and carrying out a banking task pursuant to the client's instructions when the coded secret number is identical to the client's secret number registered in the bank system.

The home banking method according to the present invention further includes recording the coded information of the banking task result on the client's card after the banking task is completely carried out.

The home banking system and the method thereof according to the present invention are embodied by installing the card interface unit to a computer equipped with a modem. In addition, the home banking system and the method thereof can safely provide the banking service to the user by the above-described feature of the card interface unit. The embodiments of the present invention discussed earlier are associated with the home banking system employing the bank card and the method thereof. However, it can be easily understood by those skilled in this field that the home banking system according to the present invention can be applied to general cards, cash cards, and associated cards issued from a certain company such as a department store, thereby providing their users with service. As the present invention may be embodied in several forms without departing from the spirit of essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A home banking method comprising:
reading and encoding coded information on a card;
transmitting the encoded information to a system connected to a remote computer network;
inputting a secret number after receiving an indication that access to the system through the remote computer network has been allowed;
encoding the secret number and transmitting the encoded secret number to the system;
changing a user's secret number after the transmitted encoded secret number has been determined to be identical to a previously registered secret number in the system;
requesting a user's home banking service transaction;
displaying the home banking service transaction result;
confirming the home banking service transaction result; and
writing a user's home banking service transaction result on the card as encoded information.

2. The home banking method of claim 1, wherein the step of changing a user's secret number includes:
encoding and transmitting a new secret number to the system.

3. The home banking method of claim 1, wherein the step of changing a user's secret number includes:
registering the new secret number in the system.

4. The home banking method of claim 1, wherein the step of changing a users secret number includes:
confirming the change to the new secret number by the user.
